(19) United States
(12) Patent Application Publication
(10) Pub. No.: US 2018/0218417 A1
(43) Pub. Date: Aug. 2, 2018

(54) Mercury Orbit Music

(71) Applicant: Yang Zhang, Azusa, CA (US)

(72) Inventor: Yang Zhang, Azusa, CA (US)

(21) Appl. No.: 15/294,697

(22) Filed: Oct. 15, 2016

(51) Int. Cl. G06Q 30/06; G06Q 20/12

(52) U.S. Cl. CPC G06Q 30/0601; G06Q 30/0641; G06Q 20/123

(57) ABSTRACT

Mercury Orbit Music is first ever all-in-one digital music platform that focuses on film scoring and soundtrack music industry. Combining all the best elements of music licensing network with an effective and efficient approach, monitoring and management music database, video-embedded soundtrack streaming service. Our platform is going to make it easier than ever for aspiring composers, music producers, network buyers, broadcasters, filmmakers, fans and merchants to interact with one another and get their business down, creating the environment in which these quality soundtracks deserve to exist. MOM (Mercury Orbit Music)'s community-based approach for composers and producer, publisher, sub publisher, merchants and fans connectivity in one cloud based ecosystem is revolutionizing the film score and soundtrack supply chain. Website content, format, concept, content resource, anything relating to business concept, business model, business platform.

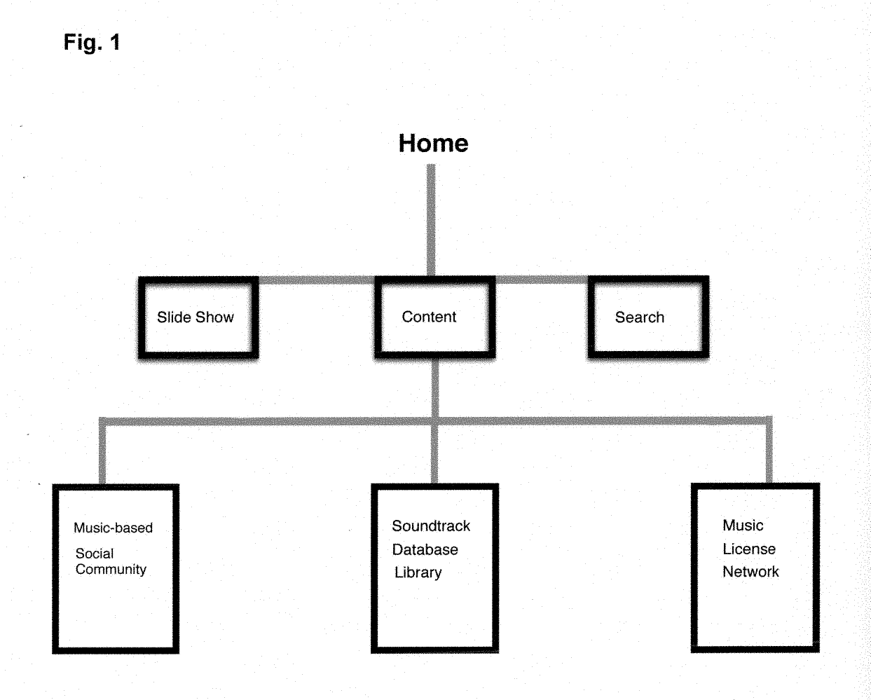

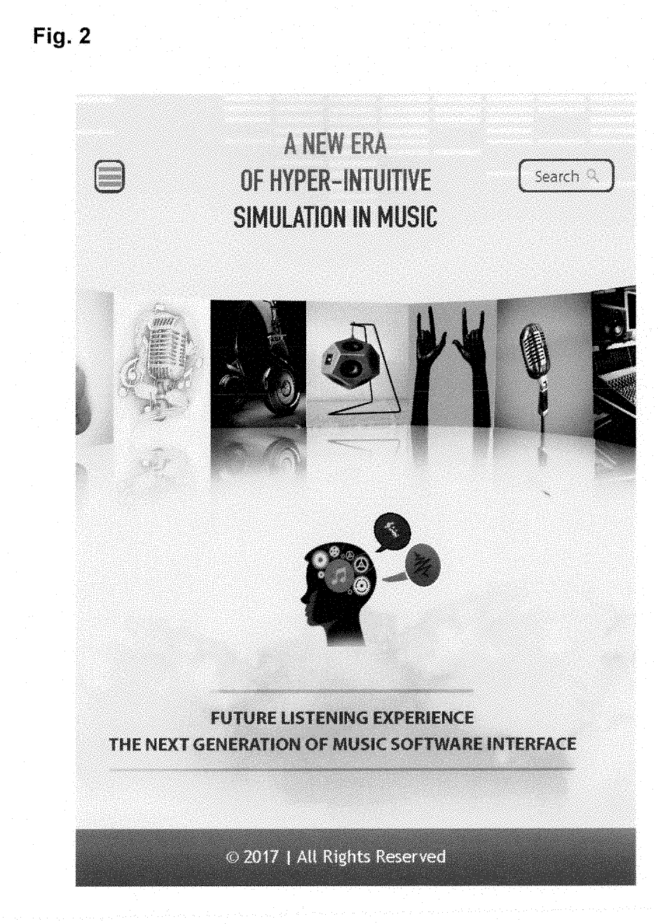

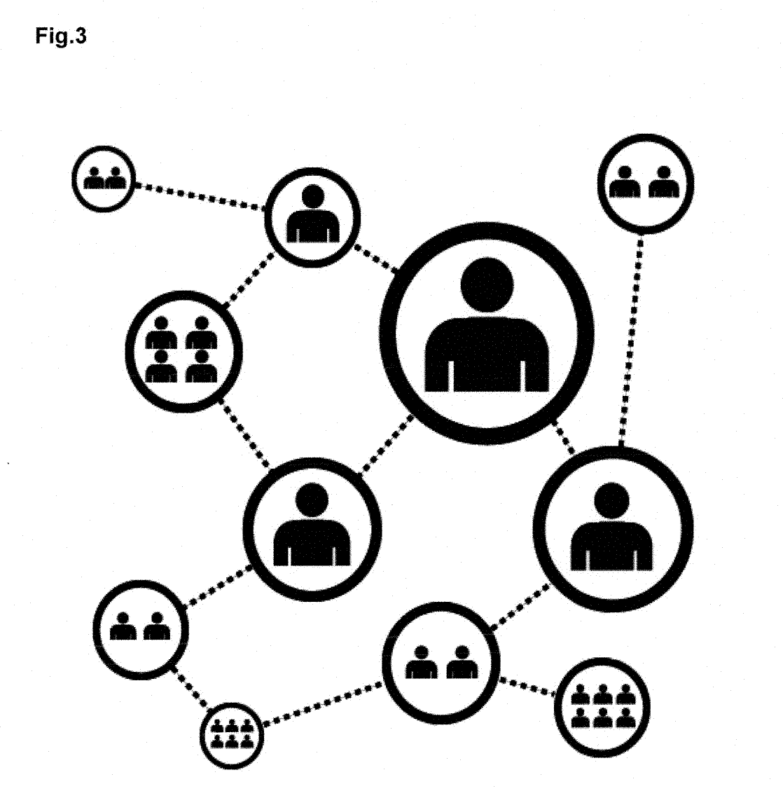

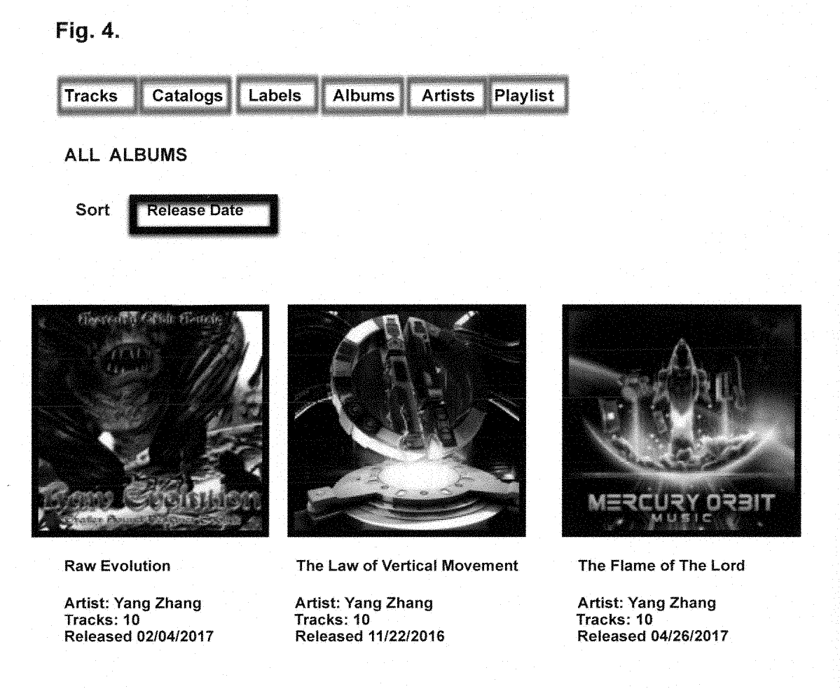

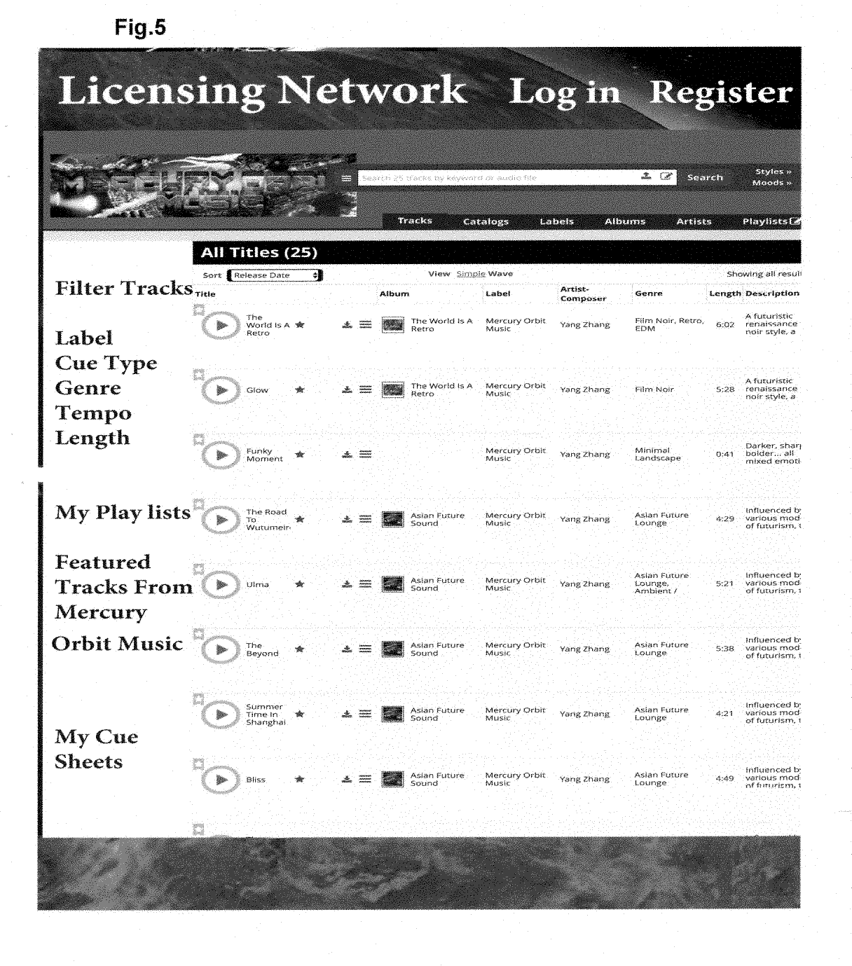

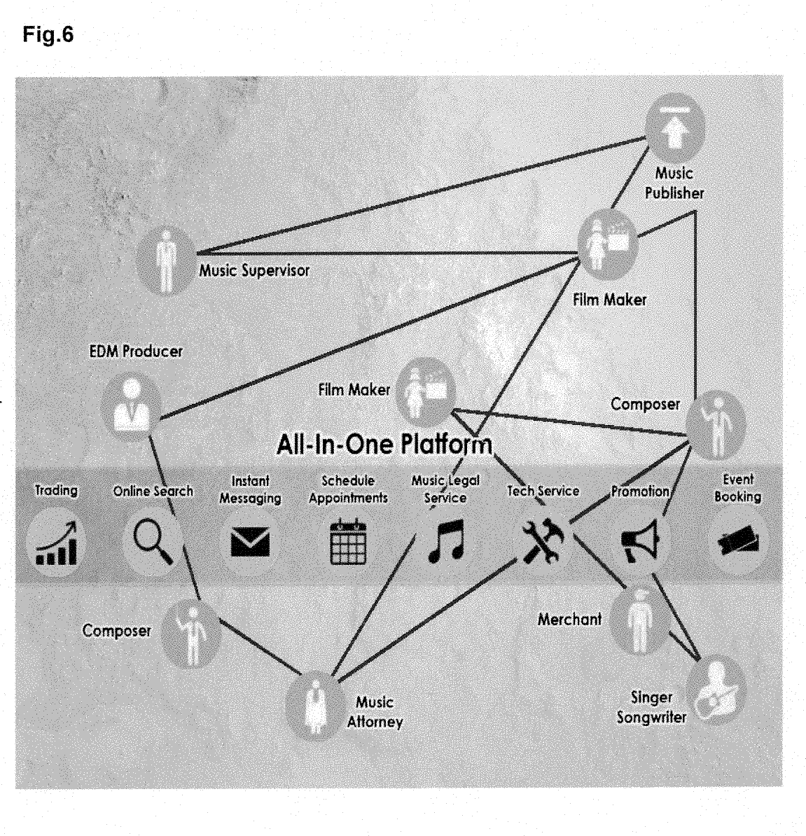

Mercury Orbit Music is the first-ever all-in-one digital music platform that focuses on film scoring and soundtrack music industry. Combining all the best elements of music licensing network with an effective and efficient approach, monitoring and management music database, video-embedded soundtrack streaming service, we decisively position the platform as an API model which can engage a variety of further applications developments.

There are four components to constitute our API-based ecosystem, namely soundtrack database, cloud-based web infrastructure, music stream service model and video embedded stream service.

1. Website content, format, concept, content resource, anything relating to business concept, business model, business platform.
